(19) United States
(12) Patent Application Publication
(10) Pub. No.: US 2019/0278139 A1
(43) Pub. Date: Sep. 12, 2019

(54) LCD WITH REACTIVE MESOGEN INTERNAL RETARDER AND RELATED FABRICATION METHODS

(71) Applicant: Sharp Kabushiki Kaisha, Osaka (JP)

(72) Inventors: Nathan James Smith, Oxford (GB); Andrew Acreman, Oxford (GB); Akira Sakai, Osaka (JP); Kiyoshi Minoura, Osaka (JP); Koji Murata, Osaka (JP); Yuichi Kawahira, Osaka (JP); Jiyun Yu, Osaka (JP)

(21) Appl. No.: 15/918,104

(22) Filed: Mar. 12, 2018

(51) Int. Cl. G02F 1/13363; G02F 1/1335; G02F 1/1337; G02F 1/1368; G02F 1/1341; G02F 1/1339; C09K 19/56

(52) U.S. Cl. CPC G02F 1/133636; G02F 1/133528; G02F 1/133514; G02F 1/133711; G02F 1/1368; G02F 1/1341; C09K 2019/525; C09K 19/56; G02F 2001/133726; G02F 2001/133633; G02F 2201/50; G02F 2413/01; G02F 2413/05; G02F 1/13394

(57) ABSTRACT

A method of fabricating a liquid crystal device (LCD) minimizes changes to optical properties of an internal RM retarder. In exemplary embodiments, the fabricating method comprises depositing a plurality of layers in an optical stack, the plurality of layers including from a viewing side: a first linear polariser; an external retarder; a colour filter substrate; a colour filter layer; an internal reactive mesogen (RM) retarder alignment layer; an internal reactive mesogen (RM) retarder; a liquid crystal (LC) layer; a thin film transistor (TFT) substrate; and a second linear polarizer. Any layer that is deposited after the internal RM retarder on a non-viewing side relative to the color filter substrate, and in direct contact with the internal RM retarder, has a solvent concentration at deposition of less than 15% of a solvent that can alter optical properties of the internal RM retarder (e.g., less than 15% NMP).

### TECHNICAL FIELD

The present invention has application within the field of displays which are particularly suitable for outdoor use in potentially high and other comparable potentially high ambient illumination situations.

### BACKGROUND ART

In recent years, the performance of transmissive or emissive type displays, such as liquid crystal display (LCDs) and organic light-emitting diode displays (OLEDs), has increased significantly in metrics such as resolution, colour gamut capability and brightness. Such displays also have decreased in cost such that they now form the large majority of the electronic displays market for most applications, both static and mobile, indoor and outdoor use. This has resulted in the retreat of reflective and transflective display types into niche applications for very high ambient illumination applications, and long battery life requirement applications.

Even applications which until very recently a reflective display technology was preferred, such as outdoor signage, e-readers and smart wristwatches, and similar devices commonly used outdoors, are now largely being served by transmissive or emissive devices, due to their increased image quality capability. In these areas, and others in which a display device may be intended for use mainly in moderate ambient light, or only occasionally high ambient light situations, such as smartphones, tablets, automotive displays and notebook PCs, attempts have been made to modify transmissive or emissive type displays to have improved performance in higher ambient lighting situations, with minimal impact on cost and dark room performance. Such modifications include the use of anti-reflection or anti-glare films to reduce reflections from the front surface of the display, and a circular front polariser to absorb reflection of ambient light from within the display. Circular polarisers are particularly effective at removing internal reflections and as result are used in displays such as LCDs in which higher dark room contrast may be obtained using standard linear polarisers (also sometimes referred to as plane polarizers), and OLEDs which do not use polarised light and therefore an emitted brightness loss is incurred.

The dominant LCD display technology for high resolution, narrow-bezel, wide-viewing angle applications such as smartphones and tablets, utilizes a Fringe-Field Switching (FFS) mode. The FFS mode is not conventionally compatible with circular polarisers, as at all voltage conditions, including zero, they have an LC director orientation, and therefore optic axis, with a large component in the polarisation plane of on-axis light, so no black state is achievable. This is also true for other commonly used LC modes such as In-Plane Switching (IPS), Twisted Nematic (TN) and Electrically Controlled Birefringence (ECB). These LC modes rely on the use of linear polarisers having a transmissive axis aligned parallel or orthogonal to the projection of the optic axis of the LC in the plane of the cell, in at least one of the display voltage states to produce a particular transmission condition.

US 2010/0134448 (Park et al., published Jun. 3, 2010) describes the use of phase compensation (retarder) films integrated into a touch panel to improve the outdoor visibility and viewing angle characteristics of an LCD. JP 2008-83492 (Epson Imagining Devices Co., Ltd) describes the use of phase compensation (retarder) films for preventing deterioration in display quality due to static electricity and reflected light. US 2017/0031206 (Smith et al., published Feb. 2, 2017) and commonly assigned PCT/JP2016/003507 describe the use of phase compensation (retarder) films for preventing deterioration in display quality due to reflected light.

### SUMMARY OF INVENTION

The present disclosure relates to display configurations that reduce ambient light reflections in liquid crystal devices (e.g., displays and light modulators), and more particularly from IPS or FFS type displays so as to provide enhanced contrast ratio and image quality particularly in conditions of high ambient light. Such display configurations use an internal retarder layer and an external retarder layer to reduce ambient light reflections in liquid crystal devices (displays and light modulators). More generally, this disclosure relates to reducing ambient light reflections in liquid crystal devices such as displays and light modulators that are normally operated with at least a first linear polariser and often with a second linear polariser, such as FFS, IPS, VAN, TN modes and the like. Accordingly, ambient light reflections are reduced in liquid crystal devices that are not normally used with circular polarisers.

By precisely matching optical properties, such as dispersion and retardation, of the internal retarder layer and the external retarder layer, an optimum image quality, including high contrast ratio, is ensured. However, it is relatively easy to damage the internal retarder layer and/or change the optical properties of the internal retarder layer during the manufacturing process, and therefore degrade the resultant contrast ratio of the LCD. Enhanced manufacturing processes are therefore disclosed to prevent any such damage.

The present disclosure relates to fabrication methods and optical configurations that minimise damage and/or changes to the optical properties that can occur to the internal retarder layer during the manufacturing process. Fabrication methods and optical configurations are described so that the optical properties of the internal retarder layer match the optical properties of the external retarder layer after all fabrication processes are complete. In exemplary embodiments, the use of a layer that contains a relatively low concentration of solvent(s), such as NMP (N-Methyl-2-pyrrolidone), is coated directly onto the internal retarder layer. In further exemplary embodiments, the use of a protection layer that is coated on top of the internal retarder layer is provided to protect the internal retarder layer from solvent(s). In still further embodiments, the order in which the LCD layers are deposited is changed to minimise damage and/or changes to the optical properties of the internal retarder layer that may occur from solvent exposure and/or high temperatures and baking processes to which the internal layer is exposed during manufacturing.

The present invention results in an LC display configured for optimum low ambient light image quality and improved high ambient lighting appearance, via absorption of the uncontrolled ambient light reflection from internal display components, while retaining the high quality transmissive display performance associated with the LC mode. Ambient light reflections in liquid crystal displays are thereby reduced, and more particularly from IPS or FFS type displays, so as to provide enhanced contrast ratio and image quality. The fabrication methods and optical configurations described minimise damage and/or changes to the optical properties that can occur to the internal retarder layer during the manufacturing process, thus enabling a display with optimum contrast ratio and low reflection of ambient lighting.

An aspect of the invention, therefore, is a method of fabricating a liquid crystal device (LCD) that minimizes changes to optical properties of the internal RM retarder. In exemplary embodiments, the fabricating method comprises depositing a plurality of layers in an optical stack, the plurality of layers including from a viewing side: a first linear polariser; an external retarder; a colour filter substrate; a colour filter layer; an internal reactive mesogen (RM) retarder alignment layer; an internal reactive mesogen (RM) retarder; a liquid crystal (LC) layer; a thin film transistor (TFT) substrate; and a second linear polarizer. Any layer that is deposited after the internal RM retarder on a non-viewing side relative to the color filter substrate, and in direct contact with the internal RM retarder, has a solvent concentration at deposition of less than 15% of a solvent that can alter optical properties of the internal RM retarder.

Another aspect of the invention is an LCD manufactured in accordance with any embodiments of the fabricating method, the LCD being configured for minimizing unwanted ambient light reflections particularly from internal components. The external retarder and the internal RM retarder are configured such that optical properties of the external retarder and the internal RM retarder are matched to negate each other for light passing through the external retarder and the internal RM retarder. Said optical properties are matched by depositing any layer that is deposited after the internal RM retarder on a non-viewing side relative to the color filter substrate, and in direct contact with the internal RM retarder, using a solvent concentration at deposition of less than 15% of a solvent that can alter optical properties of the internal RM retarder.

In exemplary embodiments, the solvent that can alter optical properties of the internal RM retarder is N-Methyl-2-pyrrolidone (NMP) solvent.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 is a schematic drawing of an optical stack arrangement of an LCD as is conventional in the art.

FIG. 2 is a schematic drawing of an exemplary LCD optical stack arrangement in accordance with embodiments of the present invention.

FIG. 3 is a drawing that defines the azimuthal orientation directions of the LCD in accordance with embodiments of the present invention.

FIG. 4 is a chart that defines the azimuthal orientation directions of some optical components pertaining to the LCD shown in FIG. 2.

FIG. 5 is a schematic drawing of another LCD optical stack arrangement in accordance with embodiments of the present invention.

FIG. 6a is a schematic drawing of another LCD optical stack arrangement in accordance with embodiments of the present invention, further including a protection layer.

FIG. 6b is a schematic drawing of another LCD optical stack arrangement in accordance with embodiments of the present invention, further including a protection layer in an alternate location within the optical stack.

FIG. 6c is a schematic drawing of another LCD optical stack arrangement in accordance with embodiments of the present invention, further including a protection layer in an alternate location within the optical stack.

FIG. 7a is a schematic drawing of another LCD optical stack arrangement in accordance with embodiments of the present invention.

FIG. 7b is a schematic drawing of another LCD optical stack arrangement in accordance with embodiments of the present invention.

FIG. 8 is a schematic drawing of another LCD optical stack arrangement in accordance with embodiments of the present invention.

FIG. 9 is a schematic drawing of another LCD optical stack arrangement in accordance with embodiments of the present invention.

FIG. 10 is a drawing depicting an internal retarder layer in which the optical axis has a twisted configuration.

### DESCRIPTION OF EMBODIMENTS

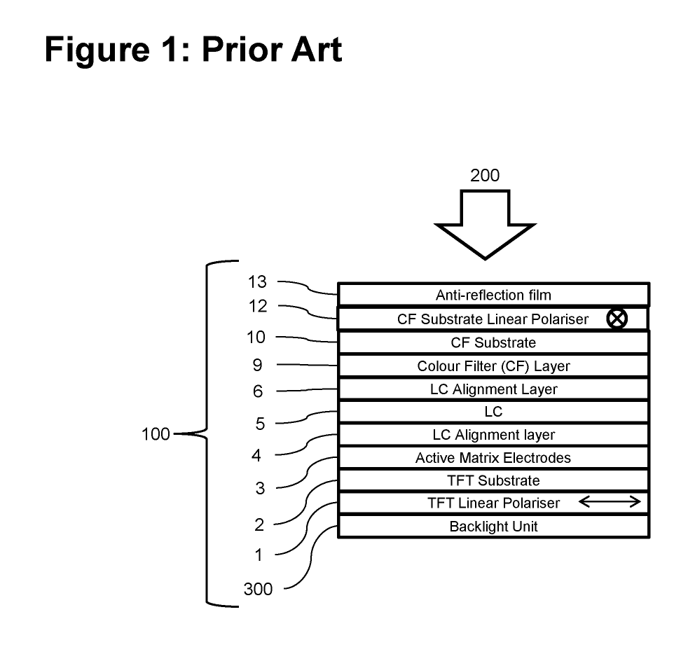

For comparison purposes for illustrating the enhancements of the present invention, FIG. 1 is a schematic drawing of an optical stack arrangement of an LCD as is conventional in the art. Referring to FIG. 1, a transmissive FFS or IPS type LCD 100 of a conventional configuration which may be considered standard in the art, typically comprises an optical stack configuration in which the liquid crystal (LC) material 5 is sandwiched between a thin film transistor (TFT) substrate 2 and colour filter (CF) substrate 10 with a uniform cell gap of typically 3-5 μm. First and second LC alignment layers 4 and 6 are disposed on the inner surfaces of the TFT substrate and CF substrate adjacent to the LC material to promote a uniform, antiparallel planar alignment of the LC. A colour filter (CF) layer 9 is disposed on the colour filter substrate 10, and an active-matrix pixel array and drive electronics 3 are disposed on the inner surface of the TFT substrate 2. Linear polarisers 1 and 12 are laminated onto the outer surfaces of both the TFT substrate and CF substrate, resulting in the transmission of linearly polarised light into the display stack from both the backlight 300 and from ambient illumination on the viewing side 200.

The viewing side sometimes is referred to as the viewer side or the outer side of the LCD, and is the side at which a person typically would look at or view images on the LCD, from which images may be provided for projection, and so on. Relative to the illustrations in the drawings, the top, upper or outer side of the LCD or of an element, component or layer of the LCD is at the top of the respective illustrations, e.g., is closer to the viewing side than to the other side of the LCD, which commonly is referred to as the non-viewing side, bottom, lower, inner, or back side, or in some cases the backlight-side of the LCD. In some instances the term “inner surface” may represent a surface that is inside the stack of components or layers of the LCD, e.g., between the respective TFT substrate 2 and CF substrate 10 of the LCD, as will be evident from the description with reference to the illustrations in the respective drawings. The term “external” generally refers to a location not between the TFT substrate 3 and CF substrate 10. The term “internal” generally refers to a location between the TFT substrate 2 and CF substrate 10.

When considering internal layers deposited upon the TFT substrate 2 and the CF substrate 10, it will be appreciated that during the manufacturing processes of each substrate, the TFT Substrate 2 and the CF substrate 10 are always referred to as the lowermost layer. Therefore, all internal layers, apart from the LC layer 5, are deposited upon (i.e. on top of) either the TFT Substrate 2 or the CF substrate 10 during the manufacturing processes prior to assembly of the LCD. An internal layer is any layer that is positioned between the TFT substrate 2 and the CF substrate 10.

A disadvantage of the transmissive FFS or IPS type LCD 100 shown in FIG. 1 is that a portion of the ambient lighting (such as sunshine etc.) incident upon the FFS or IPS type LCD 100 from the viewing side 200 is reflected back to the viewer. This unwanted reflected light degrades the perceived image quality of the FFS or IPS type LCD 100. In particular, the reflected light degrades the perceived contrast ratio of the FFS or IPS type LCD 100. A first portion of unwanted reflected ambient light comes from the upper-most layer on the viewing side and is referred to as external reflections as these unwanted reflections occur external to the image forming components of the FFS or IPS type LCD 100. In other words, external reflections have occurred from components not situated between the TFT substrate 2 and the CF substrate 10. This first portion of light reflected from FFS or IPS type LCD 100 can be reduced by use of an anti-reflection film 13 that is deposited on the viewing side of the first linear polarizer 12, and typically is the upper-most layer closest to the viewing side of the FFS or IPS type LCD 100.

A second portion of unwanted reflected ambient light comes from the materials and interfaces used within the transmissive FFS or IPS type LCD 100, and these unwanted reflections are therefore referred to as internal reflections. In other words, internal reflections have occurred from components situated between the TFT substrate 2 and the CF substrate 10. The total portion of unwanted reflected light is the sum of the first portion (unwanted external reflections) and second portion (unwanted internal reflections). Although a high quality anti-reflection film can significantly suppress unwanted external reflections, the unwanted internal reflections must be reduced to maintain high image quality of the FFS or IPS type LCD 100. Configurations intended for suppressing the unwanted internal reflections have been attempted. For example, suppression of unwanted internal reflections via the use of an internal optical retarder film and an external optical retarder film has been previously disclosed (see US 2017/0031206, cited in the background section above).

As further detailed below, a liquid crystal device (LCD) is configured for minimizing unwanted ambient light reflections particularly from internal components. In exemplary embodiments, the LCD includes a plurality of layers, the layers comprising from a viewing side: a first linear polariser; an external retarder that is made of a cyclic olefin polymer (COP) material or a cyclic olefin copolymer (COC) material; a colour filter substrate; a colour filter layer; an internal reactive mesogen (RM) retarder alignment layer; an internal reactive mesogen (RM) retarder; a liquid crystal (LC) layer; and a second linear polarizer. The external retarder and the internal RM retarder are configured such that optical properties (for example light polarization control function) of the external retarder and the internal retarder are matched to negate each other for light passing through the external retarder and the internal RM retarder, thereby simultaneously minimizing said unwanted internal ambient light reflections and maintaining high contrast ratio for displayed images.

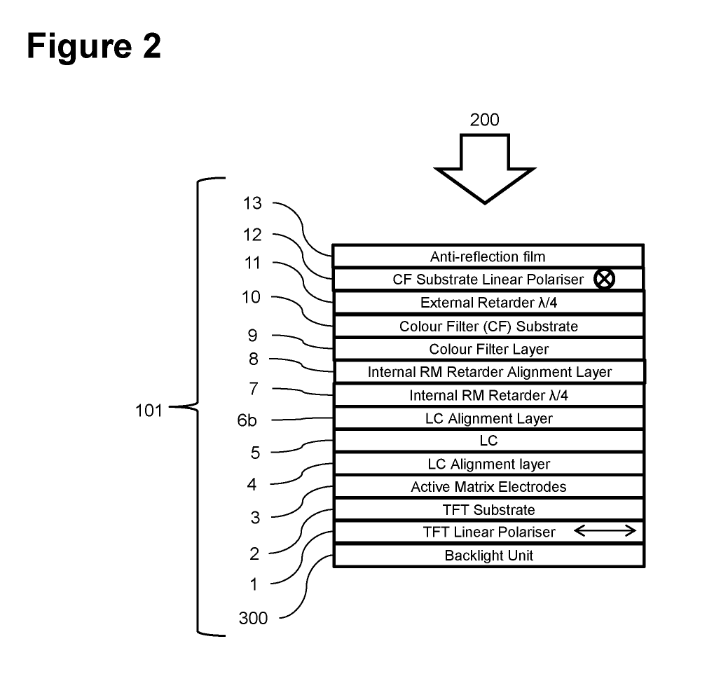

FIG. 2 is a schematic drawing of an exemplary LCD optical stack arrangement in accordance with embodiments of the present invention. Referring to FIG. 2, an FFS or IPS type LCD 101 is configured in a manner that significantly suppresses unwanted internal reflections is described. Some components are comparable as in the conventional configuration of FIG. 1, so like components are identified with like reference numerals. From the viewing side, the FFS or IPS type LCD 101 includes the anti-reflection film 13, the CF substrate linear polariser 12, an external retarder 11, the colour filter (CF) substrate 10, the colour filter layer 9, an internal reactive mesogen (RM) retarder alignment layer 8, an internal reactive mesogen (RM) retarder layer 7, the LC alignment layer 6, the LC layer 5, the LC alignment layer 4, the active matrix electrode layer 3, the TFT substrate 2, the TFT linear polariser 1 and the backlight unit 300. All components, excluding the backlight unit 300, described in the FFS or IPS type LCD 101 may be adhered together to prevent the formations of air gaps. All retarders described herein are optical retarders that may change the polarisation state of light. Accordingly, comparing FIG. 2 to FIG. 1, the LCD 101 includes the following additional layers that are not included in the conventional LCD 100: the external retarder 11, the internal RM retarder alignment layer 8, and the internal RM retarder 7.

The alignment direction of the internal reactive mesogen (RM) retarder alignment layer 8 may be formed via a rubbing process or a UV photo-alignment process. If a UV photo-alignment process is used, 254 nm UV radiation may be used (bond-breaking photo-alignment) or 365 nm UV radiation may be used (bond-making photo-alignment). The alignment direction of the internal reactive mesogen (RM) retarder alignment layer 8 defines the alignment direction of the optical axis of the internal reactive mesogen RM retarder layer 7.

To ensure that the FFS or IPS type LCD 101 shown in FIG. 2 has the same dark room (i.e. in the absence of ambient lighting) image quality as the FFS or IPS type LCD 100 shown in FIG. 1, the external optical retarder 11 and the internal RM retarder layer 7 are configured so that their optical functions, in particular their polarisation control functions, are matched to negate by each other. For example, if light that originates from the backlight 300 has its polarisation state modified from a linearly polarised state to a left-handed circularly polarised state by the internal RM retarder layer 7, then the external optical retarder 11 will convert said left-handed circularly polarised state back to said linearly polarised state. Also for example, if light that originates from an ambient light source (e.g., sunshine or other external light) has its polarisation state modified from a linearly polarised state to a left-handed circularly polarised state by the external optical retarder 11, then the internal RM retarder layer 7 will convert said left-handed circularly polarised state back to said linearly polarised state. More generally, the effect of the retarder layers 7 and 11 will then be for each to rotate the major axis of the polarisation ellipse and alter the ellipticity, but oppositely in each case, so when considered in combination, the retarder layers 7 and 11 do not change the polarisation state of the light that passes from the backlight 300 to the linear polariser 12.

Referring to FIG. 2, the external retarder 11 is a laminated film, and particularly may be configured as a quarter wave plate (QWP or λ/4) film. The external retarder 11 is a positive uniaxial material. In other words, the external retarder 11 is a positive A-plate, and is orientated at substantially) 45° (±10°) to the CF linear polariser 12. Ambient light from the viewing side becomes circularly polarised after traversing the combination of the CF linear polariser 12 and external retarder 11. Reflection of circularly polarised light from components below, i.e. further from the viewing side relative to the external retarder 11, will be absorbed by the CF linear polariser 12, and thus unwanted internal reflections are significantly reduced. The external retarder 11 and the CF linear polariser 12 may be fabricated as a composite film that forms a resultant circular polariser.

The external retarder 11 is fabricated from a Cyclo Olefin Polymer (COP) material or a Cyclo Olefin Copolymer (COC) material. An advantage of the COP or COC material is that the retardation versus wavelength is a relatively flat functional form for all optical wavelengths (red, green and blue). COP and COC materials have a relatively flat dispersion curve. A flat dispersion curve enables the combination of the external retarder 11 and CF linear polariser 12 to produce circularly polarised light across the visible spectrum, and therefore significantly reduce internal reflections in the manner described above. Another advantage of the COP or COC material is that the COP or COC material are found by the inventors to be robust to the external environmental conditions. Accordingly, the optical properties of the external optical retarder 11 remained unaffected by high ambient lighting conditions, large ambient temperature variations and large ambient humidity variations. Consequently, regardless of the environmental conditions, the external optical retarder 11 and CF linear polariser 12 produce high quality circularly polarised light across the visible spectrum, and therefore significantly reduce internal reflections. The use of COP or COC material achieves unexpected and enhanced results as compared to conventional configurations, in that one can formulate an RM material with the same dispersion characteristics as the COP or COC material, such that the external optical retarder 11 and the internal RM retarder layer 7 have optical functions that negate each other. Example COP or COC materials that may be used in the present invention include comparable materials as used in products such as, for example, NZF-UF01A (Nitto Denko), ZeonorFilm® (Zeon Corporation) and Arton Film® (JSR).

The internal RM retarder layer 7 may be coated onto the internal RM retarder alignment layer 8. The RM coating method may be a slot-die coating method or a spin coating method as are used in the art. The internal RM retarder layer 7 may be configured as a quarter wave plate (QWP or λ/4) film, and is a positive uniaxial material. The internal RM retarder layer 7 thus is a positive A-plate. The internal RM retarder layer is orientated at substantially) 90° (±10°) to the external optical retarder 11. An advantage of using an RM material for the internal RM retarder layer 7 is that the thickness required to achieve a QWP function can be sufficiently thin to minimise colour artefacts that degrade the dark room image quality. Comparably as above, unexpected and enhanced results are achieved by using an RM material for the internal RM retarder layer 7, in that one can formulate an RM material with the same dispersion characteristics as the COP or COC material, such that the external optical retarder 11 and the internal RM retarder layer 7 have optical functions that negate each other. The internal RM retarder layer 7 may have a thickness less than 3.0 μm, and particularly may have a thickness less than 1.0 μm.

To operate as described, with minimal impact on the dark-room transmissive display quality, and in particular contrast ratio, the laminated quarter wave plate external retarder 11 and the internal RM quarter wave plate retarder 7 should operate to effectively cancel as completely as possible each other's polarisation control function for all wavelengths transmitted by the LCD. It is an unexpected and enhanced result that the RM material may be formulated so that after all manufacturing processes are complete, the dispersion of the of the internal RM quarter wave plate retarder 7 closely matches that of the dispersion of the external laminated quarter wave plate retarder 11, and thus ensures a display with high image quality because dark-room contrast ratio is high and reflections from ambient light sources are low. Therefore, matching the optical properties, in particular the polarization control function of the external laminated quarter wave plate retarder 11 and the internal reactive mesogen quarter wave plate retarder 7, represents a solution with unexpected and enhanced results in terms of optical performance, high durability and relatively low Cost.

At the time of manufacturing, conventional materials for the LC alignment layer 6 (FIG. 1) often contain a relatively high concentration of N-Methyl-2-pyrrolidone (NMP) solvent. Significant exposure to the NMP solvent (and/or other similar solvents) may damage and/or change the optical properties of the internal RM retarder layer 7 such that the resultant retardation and/or the dispersion properties of the internal RM retarder 7 and the external retarder layer 11 no longer match each other upon completion of the manufacturing process, resulting in degraded contrast ratio performance of the finished product.

Fabrication methods of the present invention, therefore, operate to minimize the exposure of the internal RM retarder layer 7 to NMP or like solvents, which in turn minimizes the referenced damage and/or change to optical properties. By minimizing the exposure to NMP, there is optimization of the matching of the optical properties of the internal RM layer 7 with the optical properties of the external retarder layer 11 upon completion of the manufacturing process.

An aspect of the invention, therefore, is a method of fabricating a liquid crystal device (LCD) that minimizes changes to optical properties of the internal RM retarder. In exemplary embodiments, the fabricating method comprises depositing a plurality of layers in an optical stack, the plurality of layers including from a viewing side: a first linear polariser; an external retarder; a colour filter substrate; a colour filter layer; an internal reactive mesogen (RM) retarder alignment layer; an internal reactive mesogen (RM) retarder; a liquid crystal (LC) layer; a thin film transistor (TFT) substrate; and a second linear polarizer. Any layer that is deposited after the internal RM retarder on a non-viewing side relative to the color filter substrate, and in direct contact with the internal RM retarder, has a solvent concentration at deposition of less than 15% of a solvent that can alter optical properties of the internal RM retarder (e.g., less than 15% NMP).

In exemplary embodiments, to minimize negative effects on the internal RM layer 7, an LC alignment layer 6b may be coated on top of the internal RM retarder 7 that has a limited concentration of NMP solvent. A special class of materials have been developed, such as SE-130 (Nissan Chemical) or KPI-300B (Shenzhen Kelead Photoelectronic Materials Co. Ltd.), that has relatively low concentrations of NMP. Materials with a low NMP concentration have been developed for flexible LCD applications to prevent solvent damage to the flexible substrates. The inventors have found that using materials that have a particularly low concentration of NMP at deposition, and/or other similar solvents, for the LC alignment layer 6b are particularly well suited to the manufacture of the LCD 101 type devices that are intended to operate in high ambient light conditions, insofar as damage to, or changes of optical properties of, the internal RM retarder 7 may be prevented during the manufacturing process.

In exemplary embodiments, a concentration of the NMP solvent in the LC alignment layer 6b material may be less than 15% by weight at the time of deposition, and may be less than 2% by weight. Alternatively, the NMP solvent in the LC alignment layer 6b material may be replaced with Butyl Cellosolve (BC) solvent because BC solvent does not damage and/or change the optical properties of the internal RM retarder 7 during manufacturing. The LC alignment layer 4 may be the same material as LC alignment layer 6b, or the LC alignment layer 4 may be a different material than the LC alignment layer 6b.

After the LC alignment layer 6b is deposited, the LC alignment layer 6b is baked at a specific temperature for a specific time. The baking process also may damage and/or change the optical properties of the internal RM retarder 7, so baking time and/or temperature for the LC alignment layer 6b are selected such that the optical properties of the internal RM retarder layer 7 and the external retarder layer 11 match each other after the baking process is complete. Typical ranges of baking time and temperature of the LC alignment layer 6b may include a baking time of 30-45 minutes, and at a temperature of 150°-260°. There are no restrictions on the NMP content of the internal retarder alignment layer 8 during the initial deposition process. However, after processing (baking and rubbing/UV treatment) the internal retarder alignment Layer 8 should have an NMP content <15% so that the NMP solvent content does not damage and/or change the optical properties of the internal RM retarder layer 7 during subsequent steps in the manufacturing.

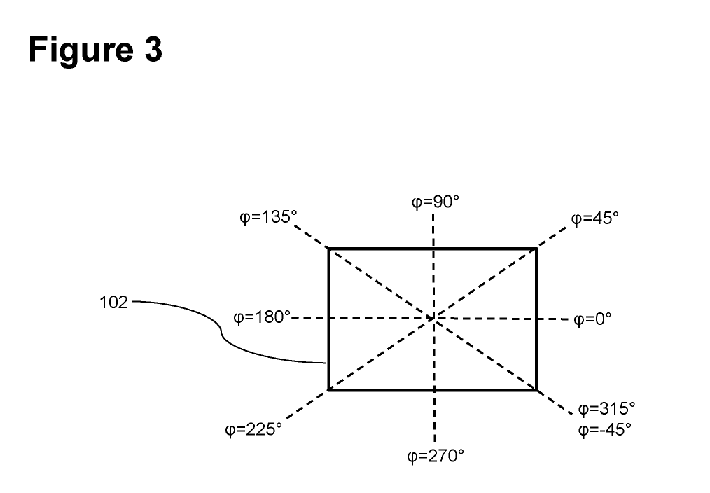

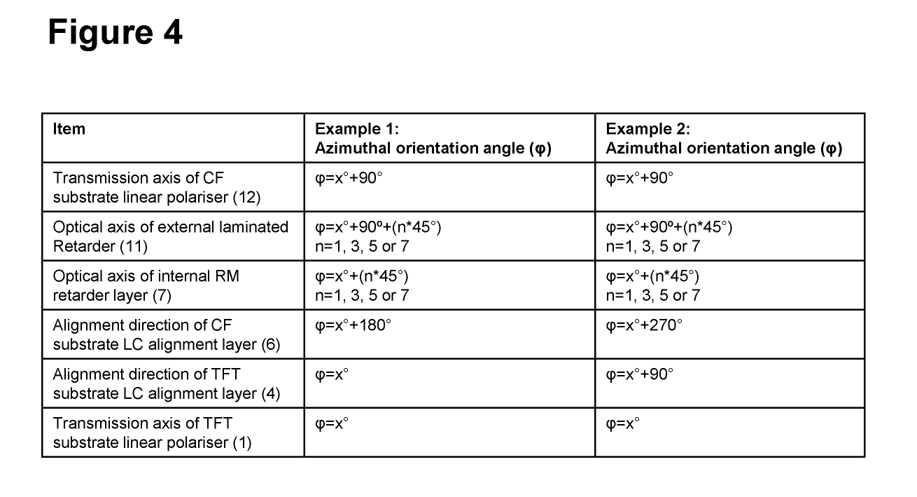

FIG. 3 is a drawing that defines the azimuthal orientation directions of in an LCD device configured as described, and FIG. 4 is a chart that defines the azimuthal orientation directions of some of the optical components. Referring to FIG. 3, a plan view of the FFS or IPS type LCD 101 is shown with azimuth orientation angle, φ, shown. Referring to FIG. 4, a table of components within the FFS or IPS type LCD 101 is shown along with azimuthal orientation angles for the respective components, which include: Transmission axis of TFT substrate linear polariser 1, alignment direction of TFT substrate LC alignment layer 4, alignment direction of CF substrate LC alignment layer 6, optical axis of internal RM retarder layer 7, optical axis of external laminated retarder 11 and transmission axis of CF substrate linear polariser 12. The azimuthal orientation direction of the internal RM retarder alignment Layer 8 and optical axis of internal RM retarder layer 7 are always the same.

Although precise values are shown for all azimuthal orientation angles φ in FIG. 4, it will be appreciated that manufacturing tolerances and related processing can limit the accuracy that can be obtained. Therefore, the azimuthal orientation angles φ referred to in FIG. 4 are aspirational for optimum performance. Referring to FIG. 4, the value of x° may take any value between 0° and 360°, and most commonly has a value of 0° or 90°. Components such as the linear polarisers 1, 12 and the retarders 7, 11 have symmetry such that alignment directions of φ and φ+180° are equivalent. Also referring to FIG. 4, the value of “n” may take the values 1, 3, 5, 7 etc. The difference in azimuthal orientation angle of the alignment direction of TFT substrate LC alignment layer 4 and the alignment direction of CF substrate LC alignment layer 6 is always 180° for a non-zero LC pretilt angle. In other words, the LC alignment is anti-parallel for LCs with a non-zero pretilt. If the LC has no pretilt angle, then the difference between the alignment direction of CF substrate LC alignment layer 6 and the alignment direction of TFT substrate LC alignment layer 4 may be 0° or 180°.

The difference in azimuthal orientation angle of the transmission axis of CF substrate linear polariser 12 and optical axis of external laminated retarder 11 is 45°, such that the CF substrate linear polariser 12 and the optical axis of external laminated retarder 11 form a circular polariser. The difference in azimuthal orientation angle of the optical axis of external laminated retarder 11 and the optical axis of internal RM retarder layer 7 is 90°, i.e. the polarisation functions of the external laminated retarder 11 and the internal RM retarder layer 7 cancel each other for light transmitted through both retarders 7, 11. The difference in azimuthal orientation angle of the transmission axis of CF substrate linear polariser 12 and transmission axis of TFT substrate linear polariser 1 is 90°, i.e. the linear polarisers 1 and 12 are crossed. Unless stated otherwise, the azimuthal orientation angles of the components shown in FIG. 4 apply to all subsequent embodiments.

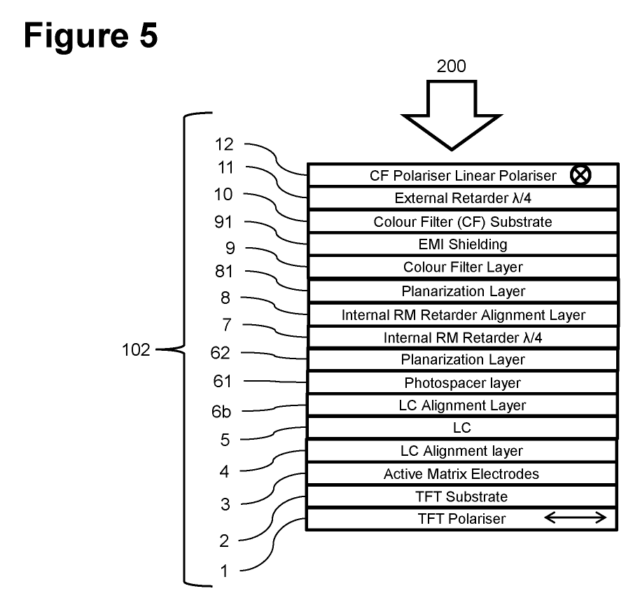

FIG. 5 is a schematic drawing of another LCD optical stack arrangement in accordance with embodiments of the present invention. FIG. 5 depicts an FFS or IPS type LCD 102 that also significantly suppresses unwanted internal reflections, and has additional components that further improve image quality. Accordingly, components in common with previous embodiments are identified with like reference numerals, with the additional components identified in FIG. 5. The FFS or IPS type LCD 102 further includes an electromagnetic shielding layer 91 that may be deposited onto the CF substrate 10 and is positioned between the colour filter substrate 10 and the colour filter layer 9. The electromagnetic shielding layer 91 is a conductive layer and may be an ITO layer.

The FFS or IPS type LCD 102 further includes a first planarization layer 81 that may be deposited on top of the colour filter layer 9 and is used to eliminate surface roughness of the colour filter layer 9. It is desirable that the planarization layer 81 is as thin as possible to avoid colour artefacts. The thickest part of the planarization layer 81 may be less than 5 μm, and in exemplary embodiments is less than 2 μm.

The FFS or IPS type LCD 102 further includes a second planarization layer 62 that may be deposited on top of the internal RM retarder layer 7 and is used to eliminate surface roughness of the internal RM retarder layer 7. It is desirable that the second planarization layer 62 also is as thin as possible to avoid colour artefacts. The thickest part of the planarization layer 62 may be less than 2 μm, and more preferably the thickest part of the planarization layer 62 may be less than 1 μm.

The FFS or IPS type LCD 102 further includes a photospacer layer 61 that may be deposited on the second planarisation layer 62. If a second planarisation layer (62) is not used, then the photospacer layer 61 may be deposited on the internal RM layer 7. The purpose of the photospacer layer 61 is to maintain a uniform thickness of the LC layer 5. The photospacer layer is patterned in a conventional manner.

As referenced above, fabrication methods of the present invention operate to minimize the exposure of the internal RM retarder layer 7 to NMP or like damaging solvents during the manufacturing process. In exemplary embodiments, the fabricating method further includes depositing an internal RM retarder protection layer after the internal RM retarder and on a non-viewing side of the internal RM retarder, wherein the protection layer has a concentration at deposition of less than 15% of the solvent that can alter optical properties of the internal RM retarder (e.g., less than 15% NMP). The protection layer may be configured in a variety of ways. For example, the protection layer may be deposited directly on the non-viewing side of the internal RM retarder layer. The protection layer may be configured as a planarization layer that is configured to eliminate surface roughness of the internal RM retarder; or the protection layer may be a separate layer that is present in combination with one or more planarization layers and/or a photospacer layer. FIGS. 5-7 depict various ways and configuration of providing a protection layer.

In the embodiment of FIG. 5, the second planarization layer 62 is coated to be in direct contact with the internal RM retarder 7. Accordingly, when the second planarisation layer 62 is coated so that planarisation layer 62 comes into direct contact with the internal RM retarder 7, the planarisation layer 62 material may have a low NMP concentration at the time of deposition to act as the protection layer to minimise damage and/or changes to the optical properties of the internal RM retarder 7. Similarly, when the second planarisation layer 62 is not used and the photospacer layer 61 is coated so that the photospacer layer 61 comes into direct contact with the internal RM retarder 7, then the photospacer layer 61 may have a low NMP concentration to minimise damage and/or changes to the optical properties of the internal RM retarder 7.

In general, therefore, any layer coated so that it comes into direct contact with the internal RM retarder 7 may have a low NMP solvent concentration to minimise damage and/or changes to the optical properties of the internal RM retarder 7. Likewise, generally as to any solvent(s) that cause damage and/or changes to the optical properties of the internal RM retarder 7, any layer coated so that it comes into direct contact with the internal RM retarder 7 may have a low concentration of such solvent(s). For example, layers 6b, 61, 62, or other layers coated to come into direct contact with the internal RM retarder 7 may have an NMP concentration of less than 15% by weight, and in exemplary embodiments may have an NMP concentration of less than 2.5% by weight. Any such unpatterned layer(s), therefore, may be regarded as a protection layer if said unpatterned layer(s) fulfill 2 criteria: firstly, damaging solvent concentration in said unpatterned layer(s) is sufficiently low to minimize the exposure of the internal RM retarder layer 7 to NMP or like damaging solvents during the manufacturing process, and, secondly, after processing said unpatterned layer(s), the unpatterned layer(s) prevents any solvent(s) from subsequently deposited layers from damaging the internal RM retarder layer 7. In other words, an unpatterned layer may be considered a protection layer if said unpatterned layer does not intrinsically cause damage and/or changes to the optical properties of the internal RM retarder 7 and said unpatterned layer also prevents subsequently deposited layers from damaging and/or changing to the optical properties of the internal RM retarder 7.

An advantage of coating a protection layer to protect the internal RM retarder 7 from exposure to NMP solvent is that a conventional LC alignment layer 6 may then be used that contains a relatively high concentration (>15%) of NMP solvent. For example, as referenced above the second planarisation layer 62 of the embodiment of FIG. 5 may also act as a protection layer that protects the internal RM retarder 7 from exposure to NMP or like solvents. Example suitable materials for the protection layer 62 may include “Lixon Coat” materials from JNC Corporation, or similar materials. Alternatively, when the second planarization layer 62 is not used, the photospacer layer 61 may act as the protection layer. In general, an advantage of a protection layer that prevents any solvent(s) from subsequently deposited layers from causing damage and/or changing to the optical properties of the internal RM retarder 7 is that the subsequently deposited layers may be of a conventional type and therefore the subsequently deposited layers may contain relatively high concentration (>15%) of NMP, or similar, solvent.

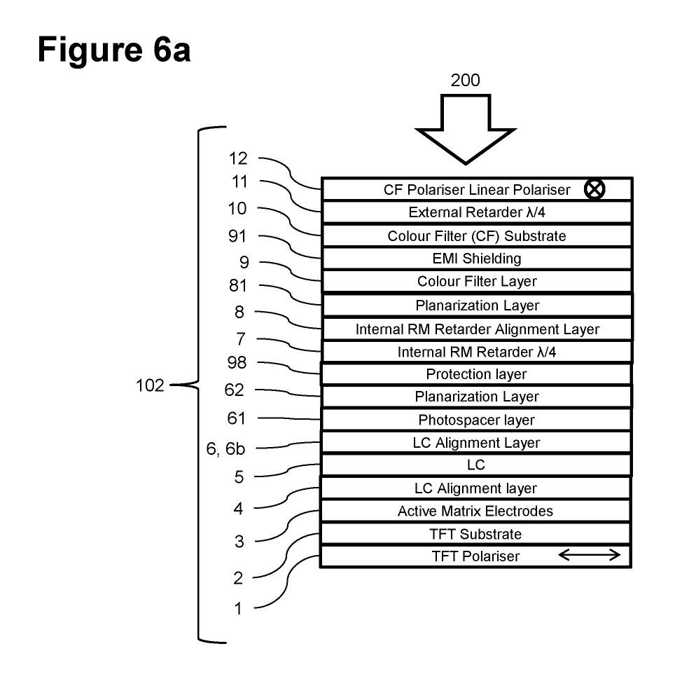

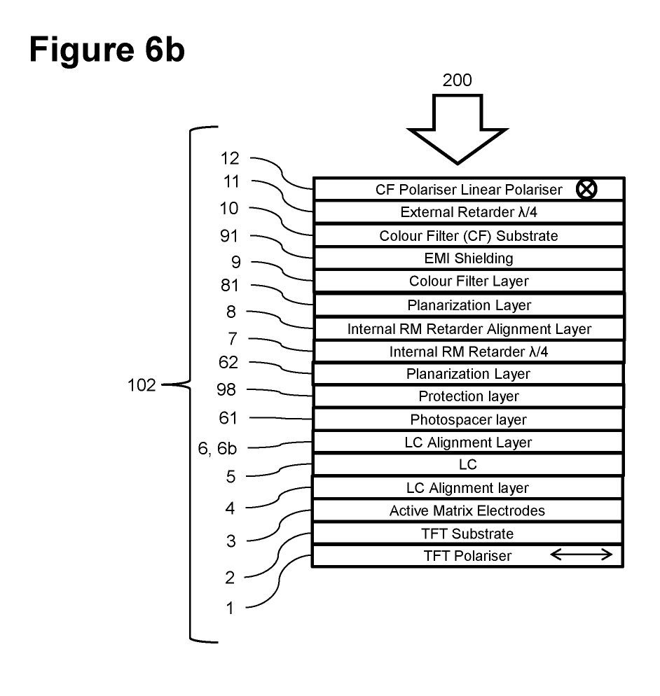

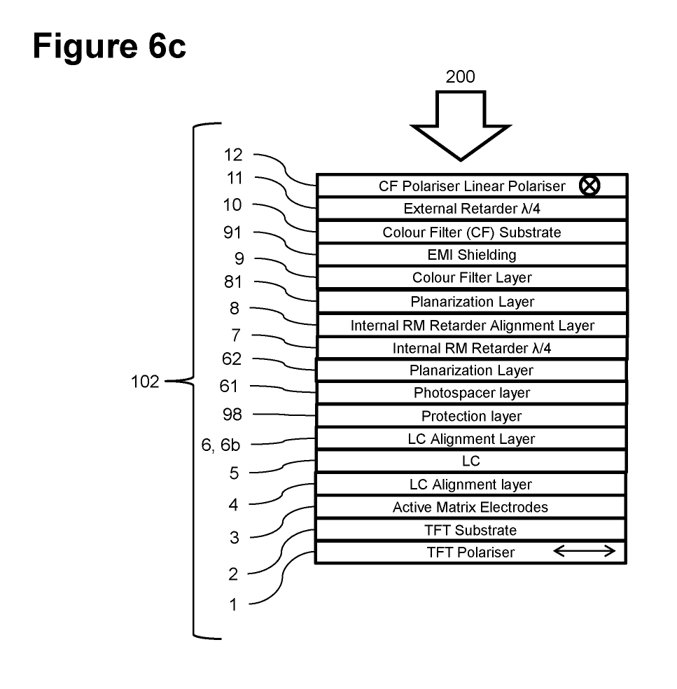

In other exemplary embodiments, a specific or separate protection layer is deposited that acts to protect internal RM retarder 7 from exposure to NMP solvent or similar solvents. FIGS. 6a, 6b and 6c are drawings depicting a separate protection layer 98 deposited on top of the internal RM retarder 7 that protects the internal RM retarder 7 from the degrading effects of exposure to NMP or similar solvents/chemicals. The protection layer must be relatively impermeable to solvents in general, and NMP solvent in particular, and therefore prevent direct contact of unwanted solvent(s) and chemicals with the internal RM retarder 7 during subsequent manufacturing processes. The protection layer 98 may be a layer of silicon nitride (SiNx) and/or silicon oxide (SiOx).

Referring to FIG. 6a, the protection layer 98 may be deposited directly upon the internal RM retarder 7. With reference to FIG. 6a, the second planarization layer 62 and/or the photospacer layer 61 may or may not be present depending upon the particular embodiment. Referring to FIG. 6b, the protection layer 98 may be deposited directly upon the second planarization layer 62, and the photospacer layer 61 may or may not be present. Referring to FIG. 6c, the protection layer 98 may be deposited directly upon the photospacer layer 61, and the second planarisation layer 62 may or may not be present.

In general, the internal RM retarder 7 may be subjected to at least 1 baking step after it has been deposited onto the CF filter substrate 10. As referenced above, the baking step(s) also may damage and/or change the optical properties of the internal RM retarder. Accordingly, it is advantageous to select baking time(s) and/or temperature(s) such that the optical properties of the internal RM retarder layer 7 and the external retarder layer 11 match each other after all baking steps are complete. The total baking time that the internal RM retarder 7 is subjected to after deposition may be between 60-150 minutes. The maximum baking temperature that the internal RM retarder 7) is subjected to after deposition may be between 150° C.-250° C. An adhesion promoter layer (not shown) may be deposited directly onto the internal RM retarder 7 so that subsequent layers that are deposited (for example, layers 6, 6b, 62, 61) have good adherence to the internal RM retarder 7.

Referring to FIG. 5 and FIG. 6, the FFS or IPS type LCD 102 further may include a positive uniaxial retarder (not shown in the figures) as is known in the art, with optical axis orientated in the viewing direction (i.e., a positive C-plate retarder) that may be positioned between the external retarder 11 and internal RM retarder 7. The purpose of the positive C-plate retarder is to compensate for the off-axis viewing degradation that can occur due to the combination of the external retarder 11 and internal RM retarder 7. The positive C-plate retarder may have a retardation value in the range 80 nm-200 nm. The optimal positive retardation value for the positive C-plate retarder may depend on the biaxiality of external retarder 11. The positive C-plate retarder may be a film laminated to the exterior of the FFS or IPS type LCD 102, for example, between the external retarder 11 and the CF substrate 10. The positive C-plate retarder may be part of a composite film that also contains the external retarder 11. The positive C-plate retarder may be part of a composite laminated film that also contains the external retarder 11 and the linear polariser 12. The positive C-plate retarder may be an RM layer disposed on the interior of the FFS or IPS type LCD 102, positioned between the internal RM retarder 7 and the colour filter substrate 10. If the positive C-plate retarder is an RM layer, then an appropriate alignment layer (not shown) may be required. The alignment layer for the RM positive C-plate retarder layer may promote vertical alignment of the RM molecules.

In the embodiments of FIG. 5 and FIG. 6, a number of additional uniaxial or biaxial retardation films (not shown) may be positioned between the TFT substrate linear polariser 1 and the CF substrate linear polariser 12 to compensate the off-axis viewing degradation that can occur due to the LC layer 5 and/or the combination of the CF substrate linear polariser and the TFT substrate linear polariser.

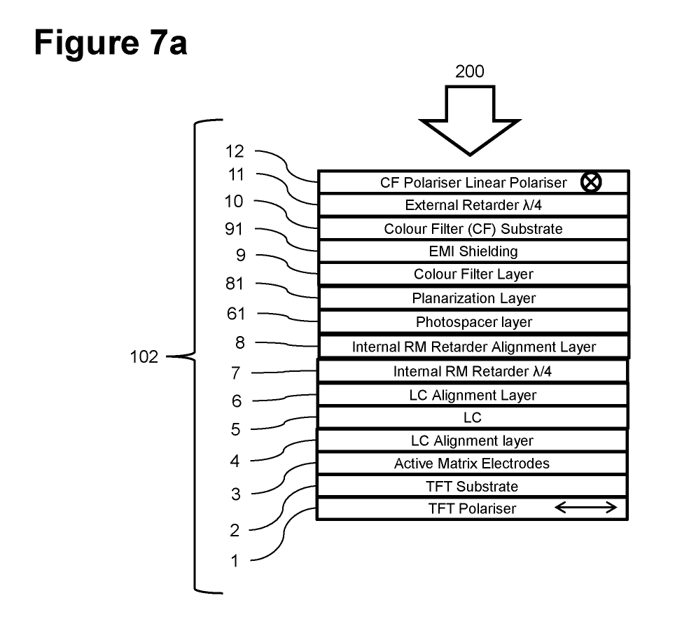

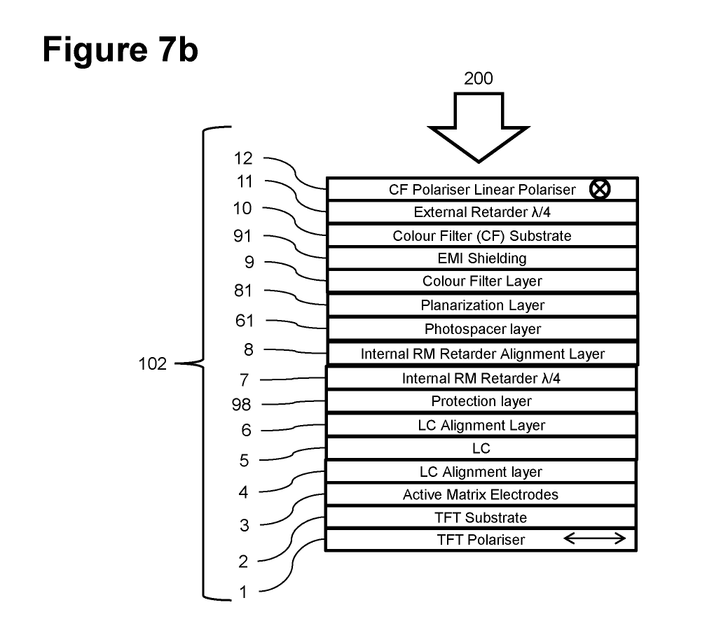

FIGS. 7a and 7b are schematic drawings of other embodiments of an LCD optical stack arrangement 102. In such embodiments, the photospacer layer 61 is deposited on the CF substrate 10 (and any intermediate layers) before deposition of the internal RM retarder 7. An advantage of this configuration is that with prior deposition of the photospacer 61, chemical solvents associated with the photospacer layer 61 will not damage and/or change the optical properties of the internal RM retarder (7), and therefore there are fewer restrictions on the type of photospacer layer material used. A further advantage of this configuration is that any baking step associated with the photospacer layer 61 will not damage and/or change the optical properties of the internal RM retarder 7, since the internal RM retarder 7 is deposited after the photospacer layer 61 baking step. Referring to FIG. 7b, a protection layer 98 as described previously may be deposited directly onto the internal RM retarder layer 7 for protection of the internal RM retarder 7 during subsequent manufacturing steps.

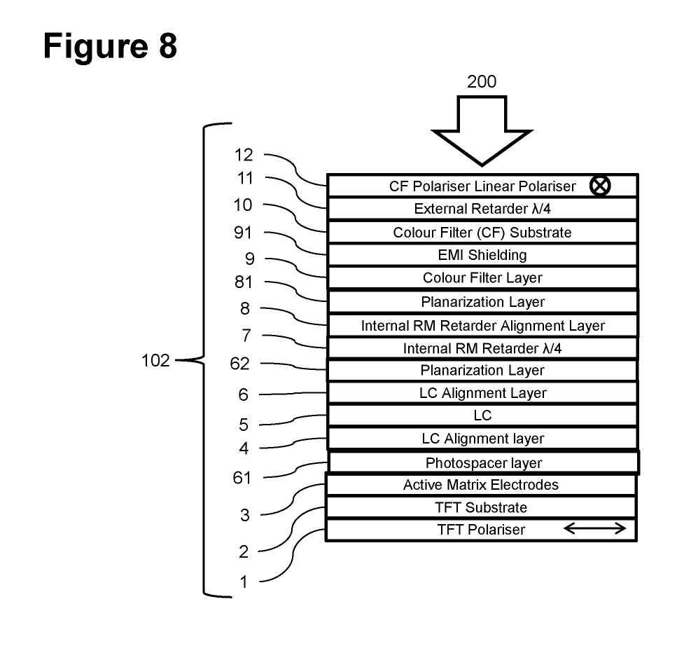

FIG. 8 is a schematic drawing of another LCD optical stack arrangement in accordance with embodiments of the present invention. In such embodiment, the photospacer layer 61 may be deposited on the TFT substrate 2 (and any intervening layers) out of contact with the internal RM retarder layer 7 and on a different substrate. An advantage of this configuration is that chemical solvents associated with the photospacer layer 61 will not damage and/or change the optical properties of the internal RM retarder 7. A further advantage of this configuration is that any baking step associated with the photospacer layer 61 will not damage and/or change the optical properties of the internal RM retarder 7 since the internal RM retarder 7 is deposited on a different substrate from the photospacer layer 61. The configuration of FIG. 8 may be combined with structural configurations shown in FIGS. 6a, 6b and 6c whereby the planarization layer 62 may also function as a protection layer for the internal RM retarder 7. In this regard, the configuration of FIG. 8 may be combined with an aspect of the configuration shown in FIG. 6a whereby a protection layer 98 may be deposited directly onto the internal RM retarder 7. The configuration of FIG. 8 also may be combined with an aspect of the configuration shown in FIG. 6b whereby a protection layer (98) may be deposited directly onto the planarisation layer 62.

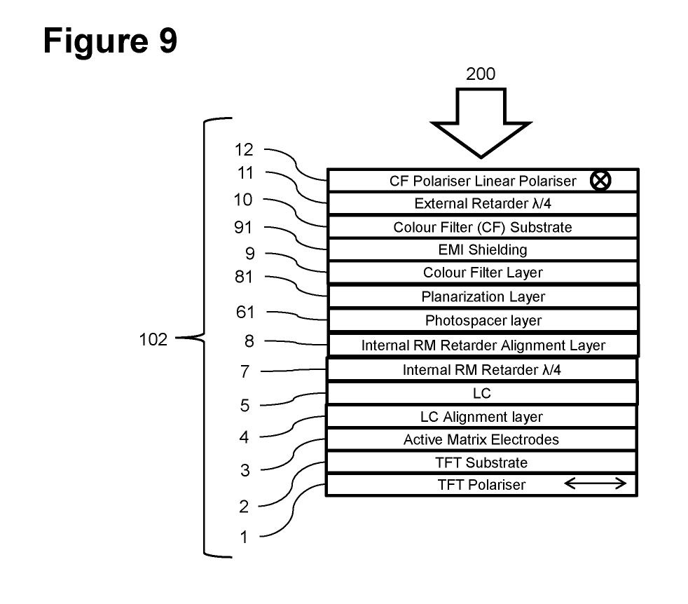

FIG. 9 is a schematic drawing of another LCD optical stack arrangement in accordance with embodiments of the present invention. In such embodiment, the LC alignment layer 6 (or 6b) has been removed altogether and the internal RM retarder 7 is processed in such a fashion that the internal RM retarder 7 performs the same LC alignment function as the LC alignment layer 6 (or 6b). Accordingly, at the interface of the internal RM retarder 7 and the LC layer 5, the LC molecules of the LC layer are aligned parallel to the transmission axis of either the TFT polariser 1 or the CF polariser 12. The azimuthal orientation directions shown in FIG. 4 can still be applied to FIG. 9.

An advantage of the configuration shown in FIG. 9 is that chemical solvents associated with the LC alignment layer 6 will not damage and/or change the optical properties of the internal RM retarder 7 as such LC alignment layer is omitted from the stack. A further advantage of the configuration shown in FIG. 9 is that any baking step that would have been associated with the LC alignment layer 6 (or 6b) is not performed, and thus will not damage and/or change the optical properties of the internal RM retarder 7. A still further advantage of the configuration shown in FIG. 9 is the reduced manufacturing cost since the LC alignment layer 6 (or 6b) is no longer present. In the absence of the LC alignment layer 6 (or 6b) from the configuration of FIG. 9, the internal RM retarder 7 must now provide the alignment function of the LC alignment layer. To achieve the correct optical axis orientation of the LC layer 5, the surface of the internal RM retarder 7 may be rubbed in a conventional fashion so as to provide the appropriate alignment direction for the LC layer 5. Alternatively, the internal RM retarder 7 may be exposed to polarised UV so as to provide the appropriate alignment direction for the LC layer 5. The polarised UV exposure may use a wavelength of approximately 254 nm and/or a wavelength of approximately 365 nm, and/or another UV wavelength typical of a Mercury vapour lamp or UV laser.

In previous embodiments, the internal RM retarder 7 is typically an A-plate retarder. As such, the optical axis of the internal RM retarder 7 is determined by the internal RM retarder alignment layer 8, and the optical axis of the internal RM retarder 7 has constant azimuthal orientation (i.e. the optical axis of the internal RM retarder 7 does not form a twisted structure).

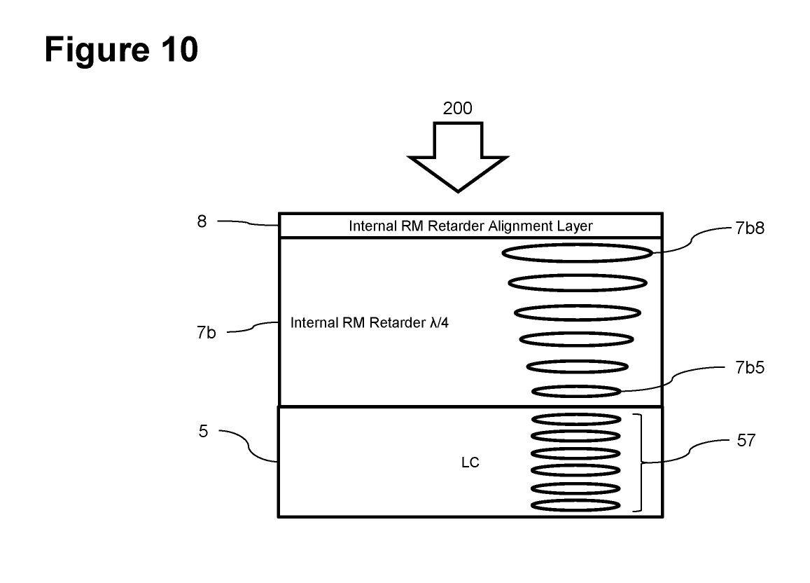

In contrast, FIG. 10 is a drawing depicting an internal RM retarder in which the optical axis has a twisted configuration. In such embodiment, an alternative internal RM retarder layer 7b is utilised that has a twisted structure, i.e. the optical axis changes azimuthal orientation so that, unlike previous embodiments, the optical axis is no longer constrained to the plane of the page. The internal RM retarder 7b has a first azimuthal orientation of the optical axis 7b8 that is aligned by the internal retarder alignment layer 8. Chiral molecules that comprise the internal RM retarder 7b, and/or chiral molecules added to the internal RM retarder 7b, cause the azimuthal orientation of the optical axis to twist out of the plane of the page to a second azimuth orientation 7b5. The second azimuthal orientation 7b5 aligns the LC molecules 57 of the LC layer 5. Within the thickness (defined as the distance in the viewing direction) of the internal RM retarder 7b, the first 7b8 and 7b5 second azimuthal orientation angles of the optical axis are configured so that the internal RM retarder 7b produces a quarter wave plate retardation function. The functional form of the twisted structure of the internal RM retarder 7b may be linear or may be non-linear. In other words, the functional form of the twist angle, φ, of the optical axis of the internal RM retarder 7b may be linear or may be non-linear in the thickness direction. The optical function or quarter wave plate retardation of the twisted internal RM retarder 7b is the same as the non-twisted internal RM retarder 7, except the molecular configuration of the internal RM retarder 7 and internal RM retarder 7b are different. Apart from the optical axis of the internal RM retarder layer 7, all other azimuthal orientation angles illustrated in FIG. 4 can be applied to FIG. 10.

An aspect of the invention, therefore, is a method of fabricating a liquid crystal device (LCD) that minimizes changes to optical properties of the internal RM retarder. In exemplary embodiments, the fabricating method includes the steps of fabricating a liquid crystal device (LCD) comprising depositing a plurality of layers in an optical stack, the plurality of layers including from a viewing side: a first linear polariser; an external retarder; a colour filter substrate; a colour filter layer; an internal reactive mesogen (RM) retarder alignment layer; an internal reactive mesogen (RM) retarder; a liquid crystal (LC) layer; a thin film transistor (TFT) substrate; and a second linear polarizer; wherein any layer that is deposited after the internal RM retarder on a non-viewing side relative to the color filter substrate, and in direct contact with the internal RM retarder, has a solvent concentration at deposition of less than 15% of a solvent that can alter optical properties of the internal RM retarder. The fabricating method may include one or more of the following features, either individually or in combination.

In an exemplary embodiment of the fabricating method, the solvent that can alter optical properties of the internal RM retarder is N-Methyl-2-pyrrolidone (NMP) solvent.

In an exemplary embodiment of the fabricating method, the method further includes depositing a liquid crystal (LC) alignment layer after the internal RM retarder on a non-viewing side relative to the color filter substrate, and in direct contact with the internal RM retarder, wherein the LC alignment layer has a concentration of NMP solvent at deposition of less than 15%.

In an exemplary embodiment of the fabricating method, the LC alignment layer includes Butyl Cellosolve solvent.

In an exemplary embodiment of the fabricating method, the method further includes depositing an internal RM protection layer after the internal RM retarder on a non-viewing side of the internal RM retarder, wherein the protection layer has a concentration at deposition of less than 15% of the solvent that can alter optical properties of the internal RM retarder.

In an exemplary embodiment of the fabricating method, the protection layer is a planarization layer deposited in direct contact with the internal RM retarder that eliminates surface roughness of the internal RM retarder.

In an exemplary embodiment of the fabricating method, the protection layer is deposited directly on the internal RM retarder and is made of silicon nitride and/or silicon oxide.

In an exemplary embodiment of the fabricating method, the method further includes depositing a planarization layer on a non-viewing side and in direct contact with the internal RM retarder that eliminates surface roughness of the internal RM retarder, wherein the protection layer is deposited on a non-viewing side of the planarization layer.

In an exemplary embodiment of the fabricating method, the protection layer is deposited in direct contact with the planarization layer.

In an exemplary embodiment of the fabricating method, the method further includes depositing a photospacer layer in direct contact with the planarization layer and that is configured to maintain uniform thickness of the LC layer, wherein the protection layer is deposited on a non-viewing side and in direct contact with the photospacer layer.

In an exemplary embodiment of the fabricating method, the method further includes after depositing the internal RM retarder, performing one or more backing steps of baking the optical stack for a time and at a temperature selected to maintain the optical properties of the internal RM retarder.

In an exemplary embodiment of the fabricating method, the one or more baking steps are performed for a total baking time of 60 to 150 minutes and/or at a temperature of 150° to 250°.

In an exemplary embodiment of the fabricating method, the method further includes subjecting a surface of the internal RM retarder to a rubbing process or a UV light process, wherein said surface is configured to align the LC molecules of the LC layer.

Another aspect of the invention is an LCD manufactured in accordance with any embodiments of the fabricating method, the LCD being configured for minimizing unwanted ambient light reflections particularly from internal components. In exemplary embodiments, the LCD includes a plurality of layers in an optical stack, the layers comprising from a viewing side: a first linear polariser; an external retarder; a colour filter substrate; a colour filter layer; an internal reactive mesogen (RM) retarder alignment layer; an internal reactive mesogen (RM) retarder; a liquid crystal (LC) layer; a thin film transistor (TFT) substrate; and a second linear polarizer. The external retarder and the internal RM retarder are configured such that optical properties of the external retarder and the internal RM retarder are matched to negate each other for light passing through the external retarder and the internal RM retarder. Said optical properties are matched by depositing any layer that is deposited after the internal RM retarder on a non-viewing side relative to the color filter substrate, and in direct contact with the internal RM retarder, using a solvent concentration at deposition of less than 15% of a solvent that can alter optical properties of the internal RM retarder. The LCD may include one or more of the following features, either individually or in combination.

In an exemplary embodiment of the LCD, the solvent that can alter optical properties of the internal RM retarder is N-Methyl-2-pyrrolidone (NMP) solvent.

In an exemplary embodiment of the LCD, an azimuthal angle between an alignment direction of the internal RM retarder and an optical axis of the external retarder is 90°.

In an exemplary embodiment of the LCD, the LCD further includes an internal RM retarder protection layer positioned between the internal RM retarder and the LC layer, wherein the protection layer does not contain solvent that can damage and/or change the optical properties of the internal RM retarder.

In an exemplary embodiment of the LCD, the protection layer is also a planarisation layer that eliminates surface roughness of the internal RM retarder.

In an exemplary embodiment of the LCD, the LCD further includes at least one planarisation layer positioned between the colour filter substrate and the LC layer.

In an exemplary embodiment of the LCD, the LCD further includes a photospacer layer positioned between the colour filter substrate and the LC layer that is configured to maintain uniform thickness of the LC layer.

In an exemplary embodiment of the LCD, the LCD further includes a photospacer layer positioned between the TFT substrate and the LC layer that is configured to maintain uniform thickness of the LC layer.

In an exemplary embodiment of the LCD, the internal RM retarder has an optical axis that forms a twisted structure that is configured to align the LC molecules of the LC layer.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

### INDUSTRIAL APPLICABILITY

Embodiments of the present invention are applicable to many display devices, and a user may benefit from the capability of the display to provide improved display visibility under higher ambient illumination, without the need for increased backlight power, particularly when the display is battery powered. Examples of such devices include mobile phones, personal digital assistants (PDAs), tablet and laptop computers, desktop monitors, and digital cameras.

### REFERENCE SIGNS LIST

1 TFT Linear Polariser
2 TFT Substrate
3 Active Matrix Electrodes
4 First LC Alignment layer
5 LC
6 Second LC Alignment Layer
6b LC Alignment layer with low NMP content
7 Internal RM Retarder layer, Internal Retarder layer
7b Internal RM Retarder layer with twisted optical axis structure
7b8 Internal RM retarder first azimuthal orientation of the optical axis
7b5 Internal RM retarder second azimuthal orientation of the optical axis
8 Internal RM Retarder Alignment Layer, Internal Retarder Alignment Layer
9 Colour Filter (CF) Layer
10 CF Substrate
11 External Retarder λ/4
12 CF Substrate Linear Polariser
13 Anti-reflection film
57 LC molecules
61 Photospacer layer
62 Second Planarization Layer
81 First Planarization Layer
91 Electromagnetic Interference Shielding
98 Protection layer
100 FFS or IPS type LCD
101 FFS or IPS type LCD With External and Internal Retarders
102 Another FFS or IPS type LCD With External and Internal Retarders
200 Viewing side
300 Backlight Unit

1. A method of fabricating a liquid crystal device (LCD) comprising depositing a plurality of layers in an optical stack, the plurality of layers including from a viewing side:
a first linear polariser;
an external retarder;
a colour filter substrate;
a colour filter layer;
an internal reactive mesogen (RM) retarder alignment layer;
an internal reactive mesogen (RM) retarder;
a liquid crystal (LC) layer;
a thin film transistor (TFT) substrate; and
a second linear polarizer;
wherein any layer that is deposited after the internal RM retarder on a non-viewing side relative to the color filter substrate, and in direct contact with the internal RM retarder, has a solvent concentration at deposition of less than 15% of a solvent that can alter optical properties of the internal RM retarder.

2. The fabricating method of claim 1, wherein the solvent that can alter optical properties of the internal RM retarder is N-Methyl-2-pyrrolidone (NMP) solvent.

3. The fabricating method of claim 2, further comprising depositing a liquid crystal (LC) alignment layer after the internal RM retarder on a non-viewing side relative to the color filter substrate, and in direct contact with the internal RM retarder, wherein the LC alignment layer has a concentration of NMP solvent at deposition of less than 15%.

4. The fabricating method of claim 3, wherein the LC alignment layer includes Butyl Cellosolve solvent.

5. The fabricating method of claim 1, further comprising depositing an internal RM protection layer after the internal RM retarder on a non-viewing side of the internal RM retarder, wherein the protection layer has a concentration at deposition of less than 15% of the solvent that can alter optical properties of the internal RM retarder.

6. The fabricating method of claim 5, wherein the protection layer is a planarization layer deposited in direct contact with the internal RM retarder that eliminates surface roughness of the internal RM retarder.

7. The fabricating method of claim 5, wherein the protection layer is deposited directly on the internal RM retarder and is made of silicon nitride and/or silicon oxide.

8. The fabricating method of claim 5, further comprising depositing a planarization layer on a non-viewing side and in direct contact with the internal RM retarder that eliminates surface roughness of the internal RM retarder, wherein the protection layer is deposited on a non-viewing side of the planarization layer.

9. The fabricating method of claim 8, wherein the protection layer is deposited in direct contact with the planarization layer.

10. The fabricating method of claim 8, further comprising depositing a photospacer layer in direct contact with the planarization layer and that is configured to maintain uniform thickness of the LC layer, wherein the protection layer is deposited on a non-viewing side and in direct contact with the photospacer layer.

11. The fabricating method of claim 1, further comprising, after depositing the internal RM retarder, performing one or more backing steps of baking the optical stack for a time and at a temperature selected to maintain the optical properties of the internal RM retarder.

12. The fabricating method of claim 11, wherein the one or more baking steps are performed for a total baking time of 60 to 150 minutes and/or at a temperature of 150° to 250°.

13. The fabricating method of claim 1, further comprising subjecting a surface of the internal RM retarder to a rubbing process or a UV light process, wherein said surface is configured to align the LC molecules of the LC layer.

14. A liquid crystal device (LCD) comprising a plurality of layers in an optical stack, the layers comprising from a viewing side:
a first linear polariser;
an external retarder;
a colour filter substrate;
a colour filter layer;
an internal reactive mesogen (RM) retarder alignment layer;
an internal reactive mesogen (RM) retarder;
a liquid crystal (LC) layer;
a thin film transistor (TFT) substrate; and
a second linear polarizer;
wherein the external retarder and the internal RM retarder are configured such that optical properties of the external retarder and the internal RM retarder are matched to negate each other for light passing through the external retarder and the internal RM retarder; and
wherein said optical properties are matched by depositing any layer that is deposited after the internal RM retarder on a non-viewing side relative to the color filter substrate, and in direct contact with the internal RM retarder, using a solvent concentration at deposition of less than 15% of a solvent that can alter optical properties of the internal RM retarder.

15. The LCD of claim 14, wherein the solvent that can alter optical properties of the internal RM retarder is N-Methyl-2-pyrrolidone (NMP) solvent.

16. The LCD of claim 14, wherein an azimuthal angle between an alignment direction of the internal RM retarder and an optical axis of the external retarder is 90°.

17. The LCD of claim 14, further comprising an internal RM retarder protection layer positioned between the internal RM retarder and the LC layer, wherein the protection layer does not contain solvent that can damage and/or change the optical properties of the internal RM retarder.

18. The LCD of claim 17, wherein the protection layer is also a planarisation layer that eliminates surface roughness of the internal RM retarder.

19. The LCD of claim 14, further comprising at least one planarisation layer positioned between the colour filter substrate and the LC layer.

20. The LCD of claim 14, further comprising a photospacer layer positioned between the colour filter substrate and the LC layer that is configured to maintain uniform thickness of the LC layer.

21. The LCD of claim 14, further comprising a photospacer layer positioned between the TFT substrate and the LC layer that is configured to maintain uniform thickness of the LC layer.

22. The LCD of claim 14, wherein the internal RM retarder has an optical axis that forms a twisted structure that is configured to align the LC molecules of the LC layer.
